(19) United States
(12) Patent Application Publication
(10) Pub. No.: US 2025/0005024 A1
(43) Pub. Date: Jan. 2, 2025

(54) Method, system, and article of manufacture for assigning values from customer record system to records in contact record system

(71) Applicant: Isbei Ltd., Grand Cayman (KY)

(72) Inventor: Abdullah Asghar Sheikh, Lahore (PK)

(21) Appl. No.: 18/342,865

(22) Filed: Jun. 28, 2023

(51) Int. Cl. G06F 16/2455; H04M 3/523

(52) U.S. Cl. CPC G06F 16/2456; H04M 3/5232

(57) ABSTRACT

Techniques for assigning values from a customer record system to records in a contact record system are disclosed. The method of the present disclosure includes: receiving a first set of records in the contact record system; receiving a second set of records in the customer record system; creating a third set that is a subset of the first set; creating a fourth set that is a subset of the first set; creating a fifth set that is a subset of the second set; creating a sixth set that is a subset of the second set; creating a seventh set based on the third set and the fifth set; creating an eighth set based on the fourth set and the sixth set; training a model based on the seventh set to achieve a trained model; and creating a ninth set based on the eighth set and the trained model.

### TECHNICAL FIELD

This disclosure generally relates to analyzing contact center data and, more particularly, to techniques for assigning values from a customer record system to records in a contact record system.

### BACKGROUND

A contact center is a system for receiving or transmitting a large number of contacts such as voice telephone calls (or “contacts”), Internet text chats, e-mails, and video calls. Contact centers may include outbound contact centers, which create a large volume of outgoing contacts from a contact center. Such outbound contact centers are often used to sell products, collect outstanding credit balances, or to survey consumer sentiment, among other applications. Contact centers may also include inbound contact centers, which receive a large volume of incoming contacts from customers. Such inbound contact centers are also used to sell or cross-sell products, to service customer support or technical support enquiries, to retain customers, upgrade and downgrade services, or in other applications.

A typical contact center maintains multiple data records systems such as a contact record system and a customer record system. The contact record system may be a log of records generated by an Automated Contact Distribution (“ACD”) system, and the customer record system may be a log of records generated by a Customer Relationship Management (“CRM”) system into which agents enter customer information as a result of a customer interaction. The ACD system may contain one or more records per contact, including information that identifies a particular contact. The CRM system may create no records, or one or more records per contact, including information that identifies an outcome of a contact such as a sale or customer satisfaction level. To optimize contact center operations, it may be necessary to join ACD records with CRM records such that contacts in an ACD system can be associated with outcomes in a CRM system. This joining requires a level of precision that may be complex and difficult to achieve.

One method to accurately join ACD records with CRM records is through assigning unique identifiers to each record that are propagated in both the ACD and CRM systems. However, unique identifiers may not be available in ACD and CRM systems because, among other reasons, not all contact centers maintain such unique identifiers. In this case, contact centers may employ other strategies to join ACD records with CRM records. U.S. Pat. No. 11,399,096 discloses strategies that may match ACD records to CRM records based on information such as timestamps, agent identifiers (“Agent ID”), customer identifiers (“Customer ID”) and other data.

However, such strategies may also be inaccurate. For example, ACD and CRM system records may be entered at different times, which dilutes the utility of timestamps. Further, Agent ID in the ACD system may be different from identifiers in the CRM system. Lastly, the clocks of the ACD and CRM systems may not be synchronized. These and other issues may make precise joining difficult.

Accordingly, there is a need for an improved system for joining ACD records with CRM records.

### SUMMARY

An embodiment of the present disclosure provides a method for assigning values from a customer record system to records in a contact record system, including: receiving a first set of records in the contact record system; receiving a second set of records in the customer record system; creating a third set that is a subset of the first set; creating a fourth set that is a subset of the first set; creating a fifth set that is a subset of the second set; creating a sixth set that is a subset of the second set; creating a seventh set based on the third set and the fifth set; creating an eighth set based on the fourth set and the sixth set; training a model based on the seventh set to achieve a trained model; and creating a ninth set based on the eighth set and the trained model, in which the fourth set is capable of being represented by a first matrix, the ninth set is capable of being represented by a second matrix, the dimension of the second matrix is based on the dimension of the first matrix; and a vector of the second matrix contains values based on the sixth set.

Optionally, in the above method, the third set and the fifth set share unique identifiers.

Optionally, in the above method, the fourth set and the sixth set do not share any unique identifier.

Optionally, in the above method, the seventh set is based on a precise join of the third set and the fifth set.

Optionally, in the above method, the eighth set is based on a cross-join of the fourth set and the sixth set.

Optionally, in the above method, the creating the ninth set based on the eighth set and the trained model includes: calculating weights corresponding to the eighth set using the trained model; and creating the ninth set based on the weights and CRM attributes from the eighth set, to generate consolidated outcomes, in which the sum of the consolidated outcomes in the ninth set does not exceed the sum of values of CRM attributes in the sixth set.

An embodiment of the present disclosure also provides a system for assigning values from a customer record system to records in a contact record system including: at least one computer processor configured to assign values from the customer record system to records in the contact record system, in which the at least one computer processor is further configured to: receive a first set of records in the contact record system; receive a second set of records in the customer record system; create a third set that is a subset of the first set; create a fourth set that is a subset of the first set; create a fifth set that is a subset of the second set; create a sixth set that is a subset of the second set; create a seventh set based on the third set and the fifth set; create an eighth set based on the fourth set and the sixth set; train a model based on the seventh set to achieve a trained model; and create a ninth set based on the eighth set and the trained model, in which the fourth set is capable of being represented by a first matrix, the ninth set is capable of being represented by a second matrix, the dimension of the second matrix is based on the dimension of the first matrix; and a vector of the second matrix contains values based on the sixth set.

Optionally, in the above system, the third set and the fifth set share unique identifiers.

Optionally, in the above system, the fourth set and the sixth set do not share any unique identifier.

Optionally, in the above system, the seventh set is based on a precise join of the third set and the fifth set.

Optionally, in the above system, the eighth set is based on a cross-join of the fourth set and the sixth set.

Optionally, in the above system, the at least one computer processor is further configured to: calculate weights corresponding to the eighth set using the trained model; and create the ninth set based on the weights and CRM attributes from the eighth set, to generate consolidated outcomes, in which the sum of the consolidated outcomes in the ninth set does not exceed the sum of values of CRM attributes in the sixth set.

An embodiment of the present disclosure further provides an article of manufacture for assigning values from a customer record system to records in a contact record system including: a non-transitory processor readable medium; and instructions stored on the medium, in which the instructions are configured to be readable from the medium by at least one computer processor configured to assign values from the customer record system to records in the contact record system, and thereby cause the at least one computer processor to operate so as to: receive a first set of records in the contact record system; receive a second set of records in the customer record system; create a third set that is a subset of the first set; create a fourth set that is a subset of the first set; create a fifth set that is a subset of the second set; create a sixth set that is a subset of the second set; create a seventh set based on the third set and the fifth set; create an eighth set based on the fourth set and the sixth set; train a model based on the seventh set to achieve a trained model; and create a ninth set based on the eighth set and the trained model, in which the fourth set is capable of being represented by a first matrix, the ninth set is capable of being represented by a second matrix, the dimension of the second matrix is based on the dimension of the first matrix; and a vector of the second matrix contains values based on the sixth set.

Optionally, in the above article of manufacture, the third set and the fifth set share unique identifiers.

Optionally, in the above article of manufacture, the fourth set and the sixth set do not share any unique identifier.

Optionally, in the above article of manufacture, the seventh set is based on a precise join of the third set and the fifth set.

Optionally, in the above article of manufacture, the eighth set is based on a cross-join of the fourth set and the sixth set.

Optionally, in the above article of manufacture, the at least one computer processor is further configured to: calculate weights corresponding to the eighth set using the trained model; and create the ninth set based on the weights and CRM attributes from the eighth set, to generate consolidated outcomes, in which the sum of the consolidated outcomes in the ninth set does not exceed the sum of values of CRM attributes in the sixth set.

An embodiment of the present disclosure provides a method for assigning values to records in a contact record system including: receiving a first set of records from the contact record system; receiving a second set of records from a customer record system; assigning each of the first set of records to each of the second set of records to create a third set of records; determining a fourth set of records that are scores for each of the third set of records; based on the third and the fourth sets of records, creating a fifth set of records that are values corresponding to each of the first set of records; and assigning the fifth set of records to the first set of records to create a resulting data set of records.

Optionally, in the above method, values from the fourth set of records are each smaller than 1; and a sum of values from the fourth set of records does not exceed 1.

Optionally, in the above method, a sum of values from the fifth set of records is equal to a sum of values from the second set of records.

Optionally, in the above method, a sum of values from the fifth set of records is smaller than a sum of values from the second set of records.

Optionally, in the above method, the contact record system is an automated contact distribution system, and the customer record system is a customer relationship management system.

Optionally, the method further includes: determining a scoring methodology based on the attributes from the first and second sets of records.

Optionally, in the above method, the scoring methodology to calculate values from the fourth set of records is devised using a known accurate set of matched records.

Optionally, the method further includes: filtering the first and second sets of records based on known matched attributes.

Optionally, the method further includes: using the resulting data set of records to create a pairing model between agents and customers.

Optionally, the method further includes: using the resulting data set of records to optimize the pairing model.

Optionally, the method further includes: using an ID based match before the receiving the first set of records from the contact record system.

Optionally, the method further includes: reevaluating the scoring methodology based on a known accurate set of matched records.

An embodiment of the present disclosure also provides a system for assigning values to records in a contact record system including: at least one computer processor configured to assign values to records in the contact record system, in which the at least one computer processor is further configured to: receive a first set of records from a contact record system; receive a second set of records from a customer record system; assign each of the first set of records to each of the second set of records to create a third set of records; determine a fourth set of records that are scores for each of the third set of records; based on the third and the fourth sets of records, create a fifth set of records that are values corresponding to each of the first set of records; and assign the fifth set of records to the first set of records to create a resulting data set of records.

Optionally, in the above system, values from the fourth set of records are each smaller than 1; and a sum of values from the fourth set of records does not exceed 1.

Optionally, in the above system, a sum of values from the fifth set of records is equal to a sum of values from the second set of records.

Optionally, in the above system, a sum of values from the fifth set of records is smaller than a sum of values from the second set of records.

Optionally, in the above system, the contact record system is an automated contact distribution system, and the customer record system is a customer relationship management system.

Optionally, in the above system, the at least one computer processor is further configured to: determine a scoring methodology based on the attributes from the first and second sets of records.

Optionally, in the above system, the scoring methodology to calculate values from the fourth set of records is devised using a known accurate set of matched records.

Optionally, in the above system, the at least one computer processor is further configured to: filter the first and second sets of records based on known matched attributes.

Optionally, in the above system, the at least one computer processor is further configured to: use the resulting data set of records to create a pairing model between agents and customers.

Optionally, in the above system, the at least one computer processor is further configured to: use the resulting data set of records to optimize the pairing model.

Optionally, in the above system, the at least one computer processor is further configured to use an ID based match before the receiving the first set of records from the contact record system.

Optionally, in the above system, the at least one computer processor is further configured to: reevaluate the scoring methodology based on a known accurate set of matched records.

An embodiment of the present disclosure further provides an article of manufacture for assigning values to records in a contact record system including: a non-transitory processor readable medium; and instructions stored on the medium, in which the instructions are configured to be readable from the medium by at least one computer processor configured to assign values to records in the contact record system and thereby cause the at least one computer processor to operate so as to: receive a first set of records from a contact record system; receive a second set of records from a customer record system; assign each of the first set of records to each of the second set of records to create a third set of records; determine a fourth set of records that are scores for each of the third set of records; based on the third and the fourth sets of records, create a fifth set of records that are values corresponding to each of the first set of records; and assign the fifth set of records to the first set of records to create a resulting data set of records.

Optionally, in the above article of manufacture, values from the fourth set of records are each smaller than 1; and a sum of values from the fourth set of records does not exceed 1.

Optionally, in the above article of manufacture, a sum of values from the fifth set of records is equal to a sum of values from the second set of records.

Optionally, in the above article of manufacture, a sum of values from the fifth set of records is smaller than a sum of values from the second set of records.

Optionally, in the above article of manufacture, the contact record system is an automated contact distribution system, and the customer record system is a customer relationship management system.

Optionally, in the above article of manufacture, the at least one computer processor is further configured to: determine a scoring methodology based on the attributes from the first and second sets of records.

Optionally, in the above article of manufacture, the scoring methodology to calculate values from the fourth set of records is devised using a known accurate set of matched records.

Optionally, in the above article of manufacture, the at least one computer processor is further caused to operate so as to: filter the first and second sets of records based on known matched attributes.

Optionally, in the above article of manufacture, the at least one computer processor is further caused to operate so as to: use the resulting data set of records to create a pairing model between agents and customers.

Optionally, in the above article of manufacture, the at least one computer processor is further caused to operate so as to: use the resulting data set of records to optimize the pairing model.

Optionally, in the above article of manufacture, the at least one computer processor is further caused to operate so as to: use an ID based match before the receiving the first set of records from the contact record system.

Optionally, in the above article of manufacture, the at least one computer processor is further caused to operate so as to: reevaluate the scoring methodology based on a known accurate set of matched records.

### BRIEF DESCRIPTION OF THE DRAWINGS

FIG. 1 is a schematic view showing a contact center system according to an embodiment of the present disclosure.

FIG. 2 is a flow diagram showing a method for assigning values from a customer record system to records in a contact record system according to an embodiment of the present disclosure.

FIG. 3 is a flow diagram showing a method for assigning values from a customer record system to records in a contact record system according to an embodiment of the present disclosure.

FIG. 4 is a schematic view showing a method for assigning values from a customer record system to records in a contact record system according to another embodiment of the present disclosure.

FIG. 5 is a schematic view showing a comparation between a time based join and a probabilistic attribution according to an embodiment of the present disclosure.

FIG. 6 is a schematic view showing a comparation between a time based join and a probabilistic attribution according to another embodiment of the present disclosure.

FIG. 7 is a schematic view showing scenarios of available joining methodologies according to an embodiment of the present disclosure.

### DETAILED DESCRIPTION

To illustrate the technical solutions of the present disclosure in a clearer manner, the drawings desired for the embodiments of the present disclosure will be described briefly hereinafter. Obviously, the following drawings merely relate to some embodiments of the present disclosure. Based on these drawings, a person skilled in the art may obtain other embodiments without any creative effort.

As used herein, the term “module” can be understood as referring to computing software, firmware, hardware and/or various combinations thereof, which can be configured as network elements, computers and/or components of systems. Modules should not be interpreted as software not implemented on hardware or firmware, or recorded on processor-readable storage media. These modules can be combined, integrated, separated and/or replicated to support various applications. The modules can be implemented on multiple devices and/or other components, which can be local or remote. In addition, these modules can be removed from one device and added to another device, and/or can be included in two devices.

As used herein, the term “unique identifier” or “Unique ID” can be understood as referring to an unique call ID shared in both ACD and CRM systems.

As used herein, the term “ACD attribute” can be understood as referring to an inherent characteristic or an object closely associated with or belonging to an ACD system. For example, ACD attributes may be call duration, call start time, call end time, etc.

As used herein, the term “CRM attribute” can be understood as referring to an inherent characteristic or an object closely associated with or belonging to a CRM system. For example, CRM attributes may be order time, product type, etc.

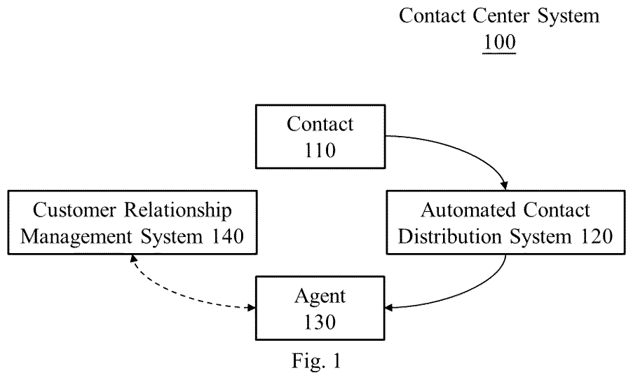

FIG. 1 is a schematic view showing a contact center system according to an embodiment of the present disclosure. The contact center system 100 may include contacts 110 arriving in the contact center system 100, an automated contact distribution system 120, agents 130 becoming available in the contact center system 100, and a customer relationship management system 140.

The ACD system 120 algorithmically assigns incoming contacts to available agents. The ACD system 120 typically maintains databases, which include information such as the time a contact was received at the contact center system 100, the agent that interacted with the contact, the duration of the contact, and some identification of the customer that initiated the contact. The ACD system 120 may create one or more database records for each contact, and each database record may have several fields, including: an identifier of the contact, such as a billing telephone number, a Customer ID and an email address; an identifier of the agent, such as Agent ID and agent name; a timestamp of the date and time of the assignment, and other information related to the assignment.

The CRM system 140 may contain a database of demographic information about individual customers such as where the customer resides, how long they have been a customer, and what products and services they are currently procuring. The CRM system 140 may also contain a database of historic customer interactions, such as records of showing a customer purchase of a product or a customer cancellation of a prior purchase. The CRM system 140 may create no database records, may modify an existing database record, or create one or more new database records, as a result of an agent's interaction with an agent desktop system (“Agent Desktop”), which is the system agents primarily use to connect with other systems for information and disposition.

Many contact center systems 100 seek to correctly correlate the information in an ACD database with the information in a CRM database. Correlating CRM records (such as a sale) with ACD records (such as a call) is known as “joining”. For example, a contact center system 100 may wish to determine whether a contact recorded in an ACD database resulted in a product purchase recorded in a CRM database. If these two systems share unique identifiers, it may allow precise correlation between the two databases. By doing such an exercise, a contact center system 100 may seek to improve its performance in several ways. For example, it may improve its ability to evaluate the performance of its agents or improve the routing strategies by which its ACD system 120 assigns contacts 110 to agents 130.

However, when there is a lack of a shared unique identifier between these two systems, it becomes difficult to precisely join CRM records with ACD records. In such a scenario, various joining strategies may be considered. For example, U.S. Pat. No. 11,399,096 discloses that a correlation between an interaction event and an outcome event can be determined by analyzing the interaction event time and the outcome event time. Such joining is also known as “time based join”, which joins ACD records to CRM records based on the records' time attributes. For example, a sale marked with a specific time stamp would be assigned to a contact whose starting and ending time stamps enclose the time stamp of the sale. U.S. Pat. No. 11,399,096 further described a methodology that allows a data matching module to determine a probability that a given pair of only one CRM record and only one ACD record is a correct match, and to select the pair with the highest probability of correctness.

However, such a time-based join method may be imprecise. While it may be likely that a particular CRM record should be assigned to a particular ACD record, it is not certain. Even though an ACD database record indicates that a particular agent received a contact from a particular customer over a particular time duration and a CRM database record indicates that the particular agent assigned a sale to the particular customer at a point in time within the particular time duration, the CRM record may still not be correctly assignable to the ACD record. Among other reasons, the reason may be that system clocks between the CRM records and the ACD records are asynchronized, or that an agent of the agents 130 may simply have delayed entering into the CRM database a sale entry for a contact of the contacts 110.

The process of assigning ACD records to CRM records becomes more imprecise if customer information in both databases do not correlate. For example, an ACD system 120 might contain the telephone number of a customer while a CRM system 140 might contain a different Customer ID.

In view of the foregoing, there may be a need for a new and improved system that assigns CRM information to ACD records. Such a system would, amongst other optimizations, allow contact centers to evaluate, compensate, and train their agents, to enhance the ACD routing strategies used to assign contacts 110 to agents 130, and to improve the messages agents 130 use with customers during their interactions more accurately.

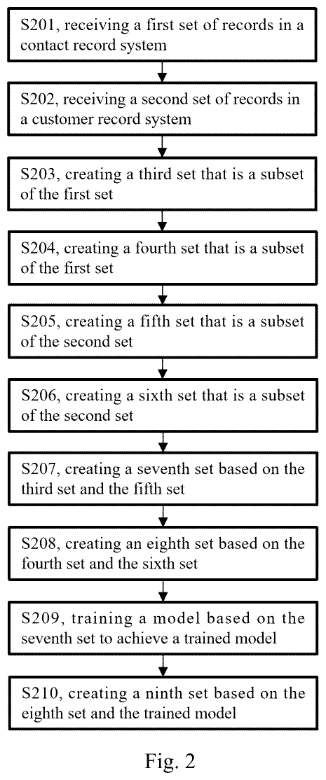

FIG. 2 is a flow diagram showing a method for assigning values from a customer record system to records in a contact record system according to an embodiment of the present disclosure, a method known as “probabilistic attribution” or “probabilistic join”.

The method of present disclosure includes: S201, receiving a first set of records in a contact record system; S202, receiving a second set of records in a customer record system; S203, creating a third set that is a subset of the first set; S204, creating a fourth set that is a subset of the first set; S205, creating a fifth set that is a subset of the second set; S206, creating a sixth set that is a subset of the second set; S207, creating a seventh set based on the third set and the fifth set; S208, creating an eighth set based on the fourth set and the sixth set; S209, training a model based on the seventh set to achieve a trained model; and S210, creating a ninth set based on the eighth set and the trained model. The fourth set is can be represented by a first matrix; and the ninth set can be represented by a second matrix. The dimension of the second matrix is based on the dimension of the first matrix; and a vector of the second matrix contains values based on the sixth set.

The probabilistic attribution is an improved joining method, which takes into account the inherent uncertainty in the joining circumstances due to possible factors like system clock asynchronization, and allows for a more accurate correlation between the two systems.

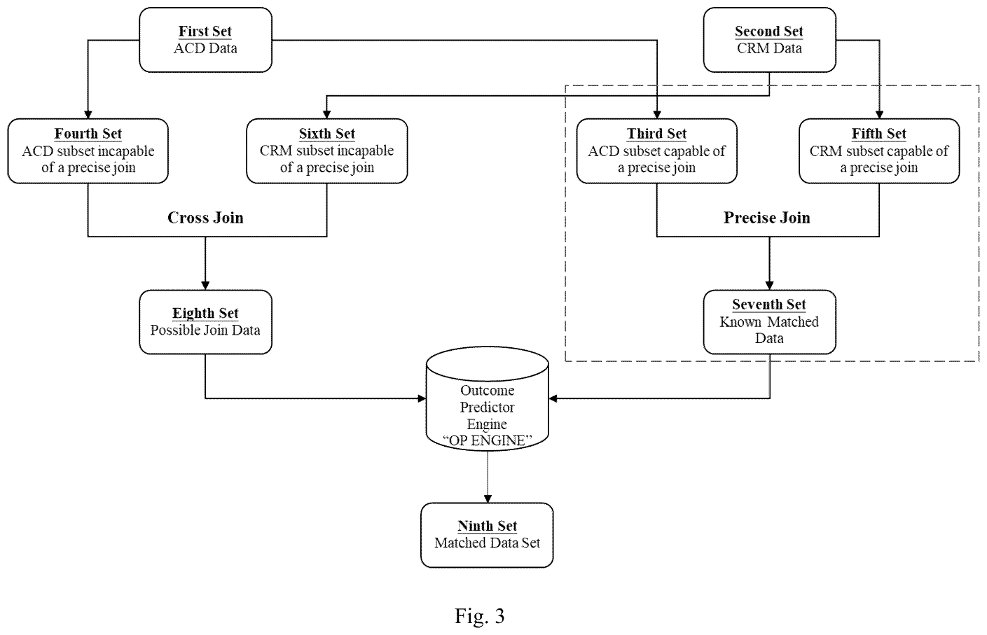

FIG. 3 is a flow diagram showing a method for assigning values from a customer record system to records in a contact record system according to an embodiment of the present disclosure. The first set is an ACD data received from records in a contact record system, and the second set is a CRM data received from records in a customer record system. Based on whether one can perform a precise join between the ACD and CRM data, the first set is divided into a third and fourth subset while the second set is divided into a fifth and sixth subset, where the third and fifth subsets may be joined using a precise join but the fourth and sixth subsets may not have a precise join available.

As shown in the right half of FIG. 3, the third set and the fifth set are subjected to a precise join such as a join based on the Unique ID, so as to obtain the seventh set that is a known matched data. The seventh set is then used to train an outcome predictor engine (“OP Engine”) using a predictive model. The trained OP Engine takes in candidate ACD records and candidate CRM records and returns aggregated expected weighted data calculated using likelihood of the CRM record being an outcome of the candidate ACD record.

As shown in the left half of FIG. 3, the fourth set and the sixth set (i.e., CRM and ACD records that cannot be precisely joined) are subjected to a cross join, that is, each ACD record in the fourth set will be joined with each CRM record in the sixth set, thereby achieving the eighth set that is the set of all possible joins between the fourth set and the sixth set. The eighth set is then inputted into the OP Engine, as candidate ACD and CRM records for the OP Engine to produce the ninth set that is a matched data set including values to be assigned and the corresponding records in the contact record system.

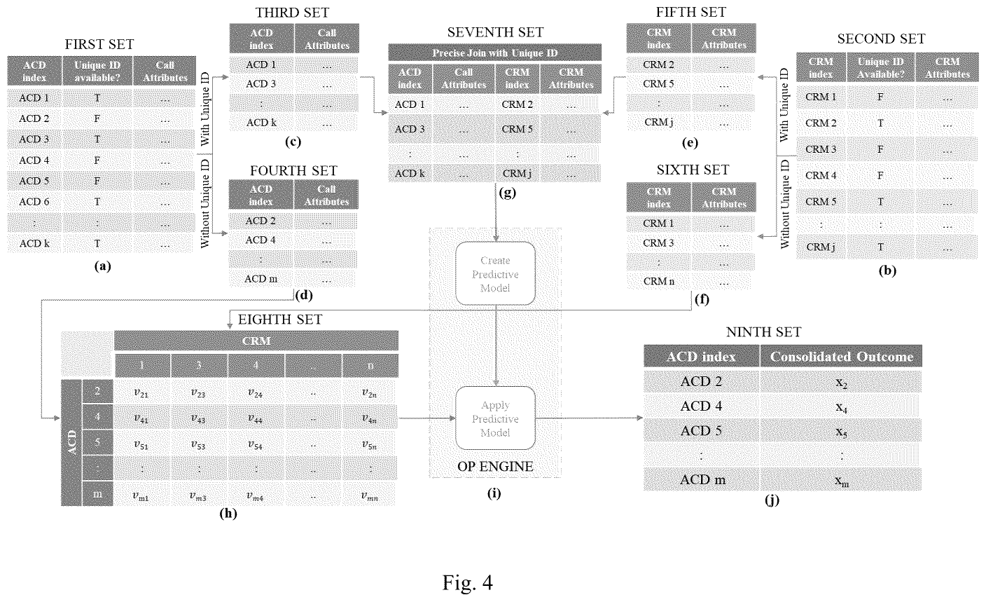

FIG. 4 is a schematic view showing a method for assigning values from a customer record system to records in a contact record system according to another embodiment of the present disclosure, and illustrates how each of the data sets in FIG. 3 is obtained step by step.

A first set of ACD records ((a) shown in FIG. 4), e.g., ACD 1, ACD 2, . . . , and ACD k that consists of call attributes is received from an ACD system. (a) shown in FIG. 4 illustrates ACD index, Unique ID availability of a call and other call attributes. The first set of ACD records is then divided into two subsets, i.e., a third set of ACD records ((c) shown in FIG. 4, i.e., ACD 1, ACD 3, . . . , and ACD k) with Unique ID and a fourth set of ACD records ((d) shown in FIG. 4, e.g., ACD 2, ACD 4, . . . , and ACD m) without Unique ID. As for Unique ID availability in the first set, “T” stands for available and “F” stands for not available. A second set of CRM records ((b) shown in FIG. 4), e.g., CRM 1, CRM 2, . . . , and CRM j that consists of CRM attributes is received from a CRM system. (b) shown in FIG. 4 illustrates CRM index, Unique ID availability of a call and other CRM attributes. The second set is then divided into another two subsets, i.e., a fifth set of CRM records ((e) shown in FIG. 4, e.g., CRM 2, CRM 5, . . . , and CRM j) with Unique ID and a sixth set of CRM records ((f) shown in FIG. 4, e.g., CRM 1, CRM 3, . . . , and CRM n) without Unique ID. As for Unique ID availability in the second set, “T” stands for available and “F” stands for not available. These divisions are based on whether or not individual records have unique identifiers that would allow for a highly accurate join across ACD and CRM systems.

The third set and the fifth set have unique identifiers, and thus the ACD record in the third set can be precisely correlated to the CRM record in the fifth set. Based on the correlation between the ACD records in the third set and the CRM records in the fifth set, a seventh set can be created, as shown in (g) shown in FIG. 4. Accordingly, the seventh set is based on a precise join of the third set and the fifth set. The seventh set may contain ACD records that consist of call attributes from the third set, as well as CRM records that consist of CRM attributes from the fifth set. Then the seventh set is inputted to the OP Engine to “train” the OP Engine (see (i) shown in FIG. 4). The OP Engine would use the seventh set, specifically the call attributes and CRM attributes therein, to create a predictive model, which is capable of taking in a candidate ACD record and a candidate CRM record without unique identifiers and returning a likelihood of the CRM record being an outcome of the candidate ACD record.

The correlation between ACD records in the fourth set and CRM records in the sixth set cannot be readily determined because the fourth set and the sixth set do not share any unique identifier. However, by applying the predictive model in the OP Engine, the correlation between ACD records in the fourth set and CRM records in the sixth set can be predicted in a probabilistic manner.

As shown in (h) shown in FIG. 4, an eighth set, e.g., v₂₁, v₂₃, v₂₄, . . . , v₂ₙ, . . . , vₘ₁, vₘ₃, vm₄, . . . , and vₘₙ, is created based on the fourth set and the sixth set. Specifically, the eighth set is based on a cross-join of the fourth set and the sixth set, that is, every ACD record in the fourth set is to be joined with every CRM record in the sixth set. Each element of the eighth set may be a vector, which may contain ACD, call attributes, and CRM attributes. For example, ACD 2 is assigned to CRM 1, CRM 3, . . . , CRM n; ACD 4 is assigned to CRM 1, CRM 3, . . . , CRM n; . . . ; ACD m is assigned to CRM 1, CRM 3, . . . , CRM n, such that the resulting matrix is the eighth set. Each item in the resultant matrix is represented by a vector containing all the attributes of the corresponding ACD record as well as the corresponding CRM record. Each vector represents the possibility that the corresponding CRM record was created as a direct result of the corresponding ACD record. In this example, v₂₁ combines the call attributes from ACD 2 with the customer relationship management attributes from CRM 1, and similarly v₄₁ combines the call attributes of ACD 4 with the customer relationship management attributes of CRM 1. Moreover, v₂₁, v₄₁, v₅₁, . . . , and vₘ₁ all include customer relationship management attributes from the same CRM record, i.e., CRM 1.

Then, the OP Engine may create a weight set that correspond to each element of the eighth set ((i) shown in FIG. 4). These weights may be labeled w_{xy}, corresponding to the labeling of the elements in the eighth set. These weights may be based on a probability that for each element v_{xy} in the eighth set, ACD x caused the creation of CRM y. For example, w₂₁ may be based on a probability that ACD 2 caused the creation of CRM 1. For assigning the weights, the OP Engine may take two inputs: the first being ACD-CRM “Precise” joined data based on unique identifiers (the seventh set, see (g) shown in FIG. 4) and the other being ACD-CRM cross-joined data (the eighth set, see (h) shown in FIG. 4). The OP Engine would train a predictive model using the ACD-CRM join of the seventh set and then use this model to predict the weightage for each ACD-CRM cross-join record of the eighth set.

Thereafter, the OP Engine generates a consolidated outcome for each ACD record in the eighth set based on the CRM entries and weights corresponding to that ACD record. For example, for ACD 2, the OP Engine would take as inputs (v₂₁, v₂₃, . . . . v₂ₙ) and (w₂₁, w₂₃, . . . , w₂ₙ) and return a consolidated outcome value, x₂. Similarly, for ACD 4, the OP Engine would take as inputs (v₄₁, v₄₃, . . . . v₄ₙ) and (w₄₁, w₄₃, . . . , w₄ₙ) and return a value, x₄. This process may continue until there is a value associated with each ACD record of the eighth set. The output of this process is the ninth set in which each ACD record from the fourth set has a corresponding consolidated outcome.

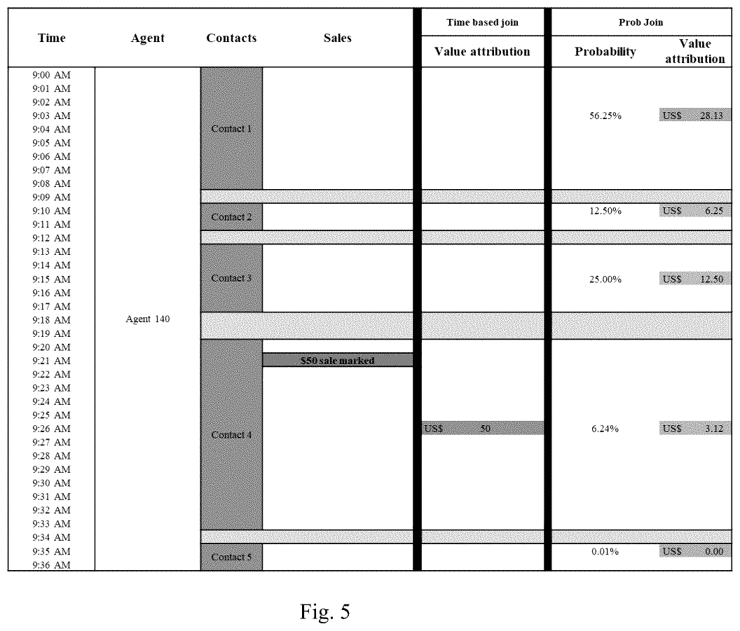

FIG. 5 is a schematic view showing a comparison between a time based join and a probabilistic attribution according to an embodiment of the present disclosure, in which the Agent ID is the unique identifier that the ACD and the CRM share. In this case, Agent 140 has 5 contacts, in which Contact 1 starts from 9:00 to 9:08 am and lasts for 9 minutes, Contact 2 starts from 9:10 to 9:11 am and lasts for 2 minutes, Contact 3 starts from 9:13 to 9:17 am and lasts for 5 minutes, Contact 4 starts from 9:20 to 9:33 am and lasts for 14 minutes, and Contact 5 starts from 9:35 to 9:36 am and lasts for 2 minutes. At 9:21, there is a sale of US $50 recorded in the CRM system 140.

The time based join may join the sale with Contact 4, as the timestamp of the sale falls into the time window of Contact 4. However, it may be probable that an agent may talk about products and services with a customer at the start of a contact, and then may mark a sale later in the contact. If so, it is unlikely that the sale happened at the start of Contact 4, as marked in the system. This may imply that the clocks of both the CRM and ACD systems were not synchronized. For example, if the clock of the CRM system was five minutes behind that of the ACD system then in the clock of the ACD system the sale would have occurred at 9:16 am. This would have the sale correctly fall towards the end of the time window of Contact 3 instead of towards the beginning of the time window of Contact 4.

The probabilistic attribution of present disclosure takes into consideration such likelihoods and assigns a probability that a sale occurred to each contact reasonably proximate in time to the sale. Based on attributes such as timestamp of the sale and the durations of Contacts 1 through Contact 5, probabilities of 56.25%, 12.50%, 25.00%, 6.24% and 0.01% is assigned to Contact 1 through Contact 5, respectively. According to the probability and the value of the sale, a value attribution is calculated for each of Contact 1 through Contact 5, that is, Contact 1 has a value attribution of US $28.13 (US $50*56.25%), Contact 2 has a value attribution of US $6.25 (US $50*12.50%), Contact 3 has a value attribution of US $12.50 (US $50*25.00%), Contact 4 has a value attribution of US $3.12 (US $50*6.24%), and Contact 5 has a value attribution of US $0.00 (US $50*0.01%). In such manner, the sale has been assigned to every contact, in proportion to the probability that that contact contributed to that sale.

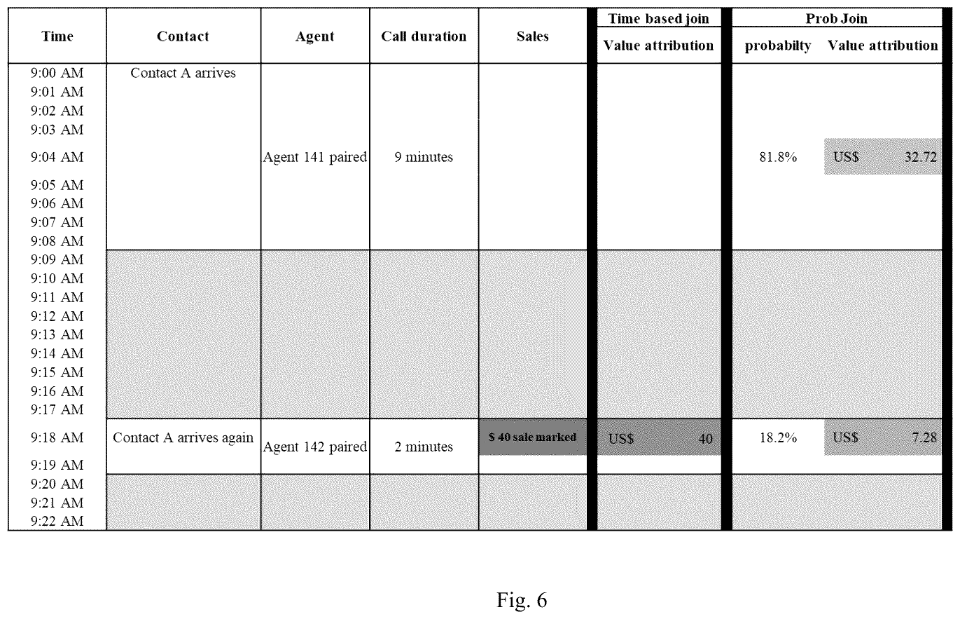

FIG. 6 is a schematic view showing a comparation between a time based join and a probabilistic attribution according to another embodiment of the present disclosure, in which the ACD system and the CRM system share a customer identifier. In this case, Contact A is associated with two Agents, 141 and 142, in which the contact paired with Agent 141 starts from 9:00 to 9:08 am and lasts for 9 minutes, and the contact paired with Agent 142 starts from 9:18 to 9:19 am and lasts for 2 minutes. At 9:18, there is a sale of US $40 recorded in the CRM system 140.

The time based join may join the sale with the contact paired with Agent 142, because the timestamp of the sale falls into the time window of the contact paired with Agent 142. However, in reality, Agent 141 may have been more responsible for the sale than Agent 142 as Agent 141 spent more time with the customer than Agent 142. After initially being convinced by Agent 141, the customer may have simply called back to confirm a sale with Agent 142. Accordingly, it may be inaccurate to only join the sale with the contact paired with Agent 142, because Agent 141 may also have contributed to the sale and his contribution may be greater than contribution from Agent 142.

The probabilistic attribution of present disclosure takes into consideration such likelihoods and assigns a probability that a sale occurred to each agent interaction reasonably proximate in time to the sale. Based on features such as timestamp of the sale and duration of the contacts paired with Agent 141 and Agent 142, a probability of 81.8% and 18.2% is assigned to the contacts paired with Agent 141 and Agent 142, respectively. According to the probability and the value of the sale, the pairing with Agent 141 has a value attribution of US $32.72 (US $40*81.8%), and the pairing with Agent 142 has a value attribution of US $7.28 (US $40*18.2%). In such manner, the sale has been assigned to every agent, in proportion to the probability that that agent contributed to that sale.

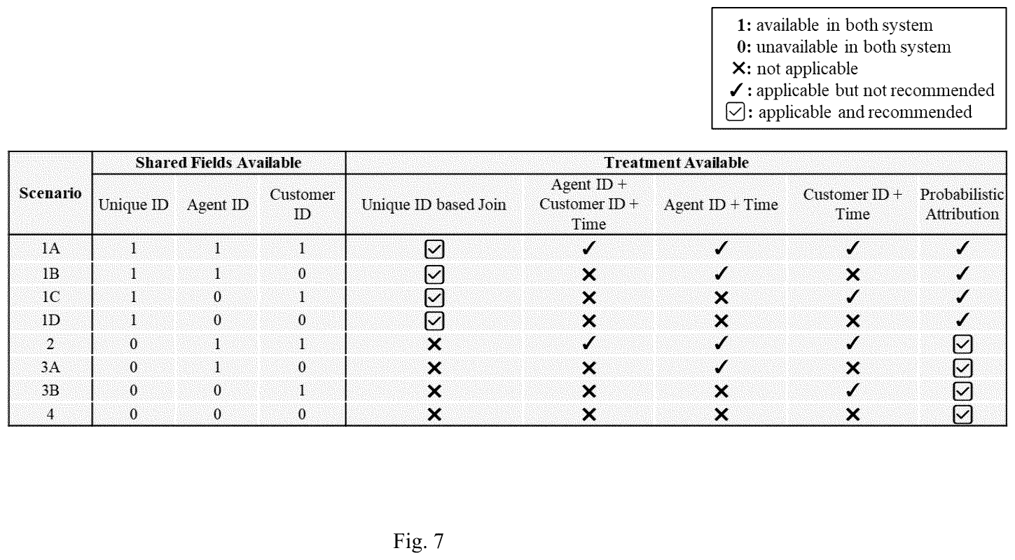

FIG. 7 is a schematic view showing scenarios of available joining methodologies according to an embodiment of the present disclosure.

In some contact center systems 100, ACD data and CRM data are easily and accurately joined. This may be because the two systems share unique data identifiers that tie specific entries in an ACD database to specific entries in a CRM database, as shown in the Scenarios 1A through 1D of FIG. 7. With shared unique identifiers, ACD records may be precisely joined to CRM records.

In the Scenario 2 of FIG. 7, unique data identifier is not available, but both Agent ID and Customer ID are present in both systems. Accordingly, ACD records may be accurately joined to CRM records based on Agent ID and/or Customer ID together with time parameters. However, the preferred method for joining would still be probabilistic attribution.

In the Scenarios 3A and 3B of FIG. 7, only one of Agent ID and Customer ID is present in both systems. ACD records may still be joined to CRM records because based on time parameters together with one of Agent ID or Customer ID. However, the vastly preferred method for joining would be probabilistic attribution.

In the Scenario 4 of FIG. 7, the ACD system and the CRM system do not share any common agent or customer identifiers, traditional joining methods may altogether fail in this scenario. However, probabilistic attribution may succeed because the probabilistic attribution of present disclosure does not essentially require either agent or customer identifiers for the joining.

In view of the above, the probabilistic attribution of present disclosure is applicable to almost all circumstance and much more successful than other joining methods in scenarios without precise join.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for assigning values from a customer record system to records in a contact record system, comprising:
receiving a first set of records in the contact record system;
receiving a second set of records in the customer record system;
creating a third set that is a subset of the first set;
creating a fourth set that is a subset of the first set;
creating a fifth set that is a subset of the second set;
creating a sixth set that is a subset of the second set;
creating a seventh set based on the third set and the fifth set;
creating an eighth set based on the fourth set and the sixth set;
training a model based on the seventh set to achieve a trained model; and
creating a ninth set based on the eighth set and the trained model;
wherein the fourth set is capable of being represented by a first matrix;
wherein the ninth set is capable of being represented by a second matrix;
wherein the dimension of the second matrix is based on the dimension of the first matrix; and
wherein a vector of the second matrix contains values based on the sixth set.

2. The method of claim 1, wherein the third set and the fifth set share unique identifiers.

3. The method of claim 1, wherein the fourth set and the sixth set do not share any unique identifier.

4. The method of claim 1, wherein the seventh set is based on a precise join of the third set and the fifth set.

5. The method of claim 1, wherein the eighth set is based on a cross-join of the fourth set and the sixth set.

6. The method of claim 1, wherein the creating the ninth set based on the eighth set and the trained model comprises:
calculating weights corresponding to the eighth set using the trained model; and
creating the ninth set based on the weights and CRM attributes from the eighth set, to generate consolidated outcomes,
wherein the sum of the consolidated outcomes in the ninth set does not exceed the sum of values of CRM attributes in the sixth set.

7. A system for assigning values from a customer record system to records in a contact record system comprising:
at least one computer processor configured to assign values from the customer record system to records in the contact record system, wherein the at least one computer processor is further configured to:
receive a first set of records in the contact record system;
receive a second set of records in the customer record system;
create a third set that is a subset of the first set;
create a fourth set that is a subset of the first set;
create a fifth set that is a subset of the second set;
create a sixth set that is a subset of the second set;
create a seventh set based on the third set and the fifth set;
create an eighth set based on the fourth set and the sixth set;
train a model based on the seventh set to achieve a trained model; and
create a ninth set based on the eighth set and the trained model;
wherein the fourth set is capable of being represented by a first matrix;
wherein the ninth set is capable of being represented by a second matrix;
wherein the dimension of the second matrix is based on the dimension of the first matrix; and
wherein a vector of the second matrix contains values based on the sixth set.

8. The system of claim 7, wherein the third set and the fifth set share unique identifiers.

9. The system of claim 7, wherein the fourth set and the sixth set do not share any unique identifier.

10. The system of claim 7, wherein the seventh set is based on a precise join of the third set and the fifth set.

11. The system of claim 7, wherein the eighth set is based on a cross-join of the fourth set and the sixth set.

12. The system of claim 7, wherein the at least one computer processor is further configured to:
calculate weights corresponding to the eighth set using the trained model; and
create the ninth set based on the weights and CRM attributes from the eighth set, to generate consolidated outcomes,
wherein the sum of the consolidated outcomes in the ninth set does not exceed the sum of values of CRM attributes in the sixth set.

13. An article of manufacture for assigning values from a customer record system to records in a contact record system comprising:
a non-transitory processor readable medium; and
instructions stored on the medium,
wherein the instructions are configured to be readable from the medium by at least one computer processor configured to assign values from the customer record system to records in the contact record system, and thereby cause the at least one computer processor to operate so as to:
receive a first set of records in the contact record system;
receive a second set of records in the customer record system;
create a third set that is a subset of the first set;
create a fourth set that is a subset of the first set;
create a fifth set that is a subset of the second set;
create a sixth set that is a subset of the second set;
create a seventh set based on the third set and the fifth set;
create an eighth set based on the fourth set and the sixth set;
train a model based on the seventh set to achieve a trained model; and
create a ninth set based on the eighth set and the trained model;
wherein the fourth set is capable of being represented by a first matrix;
wherein the ninth set is capable of being represented by a second matrix;
wherein the dimension of the second matrix is based on the dimension of the first matrix; and
wherein a vector of the second matrix contains values based on the sixth set.

14. The article of manufacture of claim 13, wherein the third set and the fifth set share unique identifiers.

15. The article of manufacture of claim 13, wherein the fourth set and the sixth set do not share any unique identifier.

16. The article of manufacture of claim 13, wherein the seventh set is based on a precise join of the third set and the fifth set.

17. The article of manufacture of claim 13, wherein the eighth set is based on a cross-join of the fourth set and the sixth set.

18. The article of manufacture of claim 13, wherein the at least one computer processor is further configured to:
calculate weights corresponding to the eighth set using the trained model; and
create the ninth set based on the weights and CRM attributes from the eighth set, to generate consolidated outcomes,
wherein the sum of the consolidated outcomes in the ninth set does not exceed the sum of values of CRM attributes in the sixth set.
